(19) United States
(12) Patent Application Publication
(10) Pub. No.: US 2011/0206349 A1
(43) Pub. Date: Aug. 25, 2011

(54) METHOD, APPARATUS AND SYSTEM FOR ANTI-PIRACY PROTECTION AND VERIFICATION

(75) Inventors: Mark Alan Schultz, Carmel, IN (US); Gregory William Cook, Lafayette, IN (US)

(73) Assignee: THOMSON LICENSING, Boulogne-Billancourt (FR)

(21) Appl. No.: 12/734,436

(22) PCT Filed: Nov. 8, 2007
(86) PCT No.: PCT/US2007/023581

§ 371 Date: Apr. 30, 2010

(51) Int. Cl. H04N 9/80

(52) U.S. Cl. 386/252; 386/E05.003

(57) ABSTRACT

A method, apparatus and system for anti-piracy protection and verification include a first projection device configured to project image frames onto a screen. A feedback device records a plurality of consecutive frames, an image analyzing module analyzes image properties of the recorded frames and a modulator creates anti-sampling system content to be projected contemporaneously with the image frames. The projected anti-sampling system content, while virtually invisible to the human eye, is detectable by sampling systems such as camcorders, thus rendering any such pirated recordings of the protected image content useless. The first projection device can include a security processor configured for comparing the recorded content with an expected content in real-time. A display enable/disable module is provided for disabling the projection of the content on the screen if the recorded content does not match the expected content.

### TECHNICAL FIELD OF THE INVENTION

The present invention generally relates to content security, and more particularly, to a method, apparatus and system for providing and verifying anti-camcorder content for anti-piracy purposes of, for example, film and digital media.

### BACKGROUND OF THE INVENTION

Piracy concerns in connection with the theatrical exhibition of motion picture content are well known. For example, in the regular course of exhibiting a film, a customer in the theater may surreptitiously record the film using, for example, a hand held camcorder. Currently, piracy of content due to illegal recording is estimated to cost $3 billion in lost revenue.

Some current methods of protecting the content include: 1) transmitting patterns in the near-IR spectrum, and 2) modifying the content intended for Digital Cinema projectors to implement visible light anti-camcorder methods. The advantage of the near-IR method is that it is display independent; however, it is speculated that specialized near-IR filters for camcorders might render this technique less than effective.

With respect to the modification of Digital Cinema content, this has the advantage that no static filter will be able to defeat this technique; however, with effective frame rates necessary to implement this technique estimated to be above 100 Hz (well above the minimum 24 Hz or 48 Hz required for standard cinema content) a much more complex, and thus costly projector to facilitate anti-camcorder methods would be required. In addition, this method obviously does not protect film (non-digital) content.

One example of a system for protection of movie content (both film and digital) is the method of transmitting near IR images to the screen, for example, as described in U.S. Pat. No. 6,559,883. The near-IR images may be sensed by a camcorder device, but are not visible to the naked eye. In addition, there is also proposed a system including infrared sensors which senses whether an anti-camcorder system is being used and reports its findings to assist in enforcement and reporting of an anti-piracy system (e.g., see U.S. Pat. No. 6,771,349.) While this system is independent of the projection method, the weakness of this system is its reliance on near-IR transmission, for which it is speculated that the use of a specialized near IR filter would render this technique less effective than required for content protection.

A second method of modifying the content intended for Digital Cinema projectors is based on the fact that the human eye is not a sampling system whereas a camcorder system is. Thus, by transmitting frames at other than the standard of 24 Hz, one can take advantage of aliasing and produce various beating patterns in the passband of the camcorder invisible to the naked eye. In addition to modulating the luma of the visible signal, one can also modulate the chroma of the visible signal, and still not be visible. While the advantage with this method is that no static filter can be used to eliminate the unwanted signals and thwart the system, there are a number of difficulties with this method, however. A first (and main) problem is that implementing this system will require a projector to be constructed well beyond its nominal design requirements, thus driving up the costs of the projector immensely. For example, such an anti-camcorder projector will need to be capable of producing frame rates of well over 100 Hz, which is over three times that required under nominal conditions. In addition, given the limitations of the frame rate of projectors, it is speculated that a smoothing filter of 1/15^{th} of a second could render the protected content useless in spite of the tremendous cost of building the device.

Further, while many anti-camcorder and watermarking systems are being designed today to discourage illegal copying in movie theaters, the main problem with many of such techniques is lack of verification that the intended anti-camcorder protection is actually appearing on the screen during playback in a theater. Indeed, most of the security techniques for digital cinema are placed in the projector. Once the light leaves the projector, there is no feedback to verify or monitor the success of the security technique. This is a major flaw, since the security system can be tampered with either before the content arrives in the theater or after the content is playing. Some of the proposed systems rely on theater personnel to maintain honesty, which can present a problem. Since the staff of a theater is often kept to a minimal number, all of the screens and theaters cannot be monitored all of the time.

For example, a multiple projector system that provides anti-camcorder content can be defeated by simply turning off the additional projector that is providing the anti-camcorder content. Techniques using mechanical shutters to add flicker can also be defeated by turning off the motor that drives the shutter or mechanically moving the shutter away from the projected light.

Accordingly, a method, apparatus and system for preventing unauthorized piracy of movie content as well as providing real-time monitoring and verification of anti-camcorder protection which avoids the limitations and deficiencies of, for example, near-IR and digital content modulation, is highly desirable.

### SUMMARY OF THE INVENTION

Embodiments of the present invention address various deficiencies of the prior art by providing a method, apparatus and system for preventing unauthorized piracy of, for example, movie content as well as providing real-time monitoring and verification of anti-piracy protection. The various aspects of the embodiments of the present invention described here are useful under all content delivery techniques such as projection techniques (e.g., film, Digital Cinema, etc.), are not vulnerable to near IR filters, and do not require intimate foreknowledge of the content.

In one embodiment according to the present principles, a method, apparatus and system are provided for anti-piracy protection, namely, in a theater or other environment in which video content is publicly displayed. That is, in various embodiments of the present invention, a second projection device is provided to project anti-sampling system content simultaneously with a main presentation (movie) content. A feedback device (e.g., visible light camera) is provided to verify that the second projector is operating in a region of the presentation and/or in a portion within each image such that the anti-sampling system content is virtually invisible to the naked human eye, yet effective in preventing a useful video sequence from being recorded by a camcorder or other video recording device during playing of the movie.

Further, in accordance with various embodiments of the present invention, an automated, real-time monitoring and verification system is provided for viewing the projected content in real-time and verifying that the anti-camcorder security content that is intended to be applied to the projected content is actually on the screen. For example, in one embodiment utilizing a security processor and a feedback device (camera); an anti-tamper system can be provided for real-time testing of image content being played on a screen to verify that the intended security content is indeed on the screen. This feedback mechanism may be used to alert, for example, the theater owner that the security system has been tampered with and can be used to enable the turning off the content projector and discontinue playing of the content.

In one embodiment of the present invention, a method for providing and verifying anti-camcorder content includes determining, from at least a portion of a projected original image content, anti-sampling content suitable for projection contemporaneously with the original image content such that the anti-sampling content is not visible to a human eye but is destructive to the image quality of the original image content when recorded by a sampling device, projecting the anti-sampling content contemporaneously with the original image content, and capturing the contemporaneously projected content for verifying that the anti-sampling content is present in the captured content.

In an alternate embodiment of the present invention, a system for providing and verifying anti-camcorder content includes a content capturing device configured to capture at least a portion of a projected original image content, a control unit for determining, from at least the captured portion of the projected original image content, anti-sampling content suitable for projection contemporaneously with the original image content such that the anti-sampling content is not visible to a human eye but is destructive to the image quality of the original image content when recorded by a sampling device, and a projection device for projecting the anti-sampling content contemporaneously with the original image content wherein the content capturing device captures the contemporaneously projected content for verification by the control unit that the anti-sampling content is present in the captured content.

In an alternate embodiment of the present invention, the anti-piracy control unit of the above described system includes an image analyzer for determining and analyzing image properties of a projected original image content, and a modulator for determining, using at least the determined and analyzed image properties of the original image content, anti-sampling content suitable for projection contemporaneously with the original image content such that the anti-sampling content is not visible to a human eye but is destructive to the image quality of the original image content when recorded by a sampling device.

### BRIEF DESCRIPTION OF THE DRAWINGS

The teachings of the present invention can be readily understood by considering the following detailed description in conjunction with the accompanying drawings, in which:

FIG. 1 depicts a high level block diagram of an anti-piracy protection and verification system in accordance with an embodiment of the present invention;

FIG. 2 depicts an exemplary illustration of an image having anti-camcorder content as viewed by a sampling system in accordance with an embodiment of the present invention;

FIG. 3 depicts an exemplary illustration of images projected by various components of an anti-camcorder system in accordance with an embodiment of the present invention;

FIG. 4 depicts a flow diagram of a method for providing anti-camcorder system content in accordance with an embodiment of the present invention;

FIG. 5 depicts a high level block diagram of a system for providing and verifying anti-piracy content in accordance with an embodiment of the present invention;

FIG. 6 depicts a high level block diagram of an anti-piracy protection and verification system in accordance with an alternate embodiment of the present invention;

FIG. 7 depicts a more detailed diagram of the system of FIG. 6 in accordance with an embodiment of the present invention; and

FIG. 8 depicts a flow diagram of a method for providing and verifying anti-camcorder content in real-time in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

Embodiments of the present invention advantageously provide a method, apparatus and system for anti-piracy protection and verification. Although the present invention will be described primarily within the context of a specific anti-piracy protection and verification system and device, the specific embodiments of the present invention should not be treated as limiting the scope of the invention. It will be appreciated by those skilled in the art and informed by the teachings of the present invention that the concepts of the present invention can be advantageously applied in substantially any content delivery and display environment for providing anti-piracy protection and verification.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

In accordance with various embodiments of the present invention, a method, apparatus and system is described for providing and verifying anti-sampling content for anti-piracy purposes of, for example, film and digital media in a theater or other environment in which video content is publicly displayed. In various embodiments of the present invention, anti-sampling system content is applied to a main presentation (movie) content, and a feedback device (e.g., visible light camera) is provided to verify that the anti-sampling content is operating in a region of the presentation as well as in a portion within each image where it would be virtually invisible to the naked human eye, yet effective in preventing a useful video sequence from being recorded by a camcorder or other video camera device during playing of the movie.

An automated, real-time monitoring and verification system can be provided for viewing the movie in real-time and verifying that the anti-camcorder security content that is intended to be applied to the screen is actually on the screen. Even further, in various embodiments of the present invention, a security processor and a feedback device (camera) are utilized to provide an anti-tamper system for real-time testing of image content being played on a screen to verify that the intended security content is indeed properly appearing on the screen. This feedback mechanism can be used to alert the theater owner that the system has been tampered with and/or automatically disable the content source and discontinue display of the content.

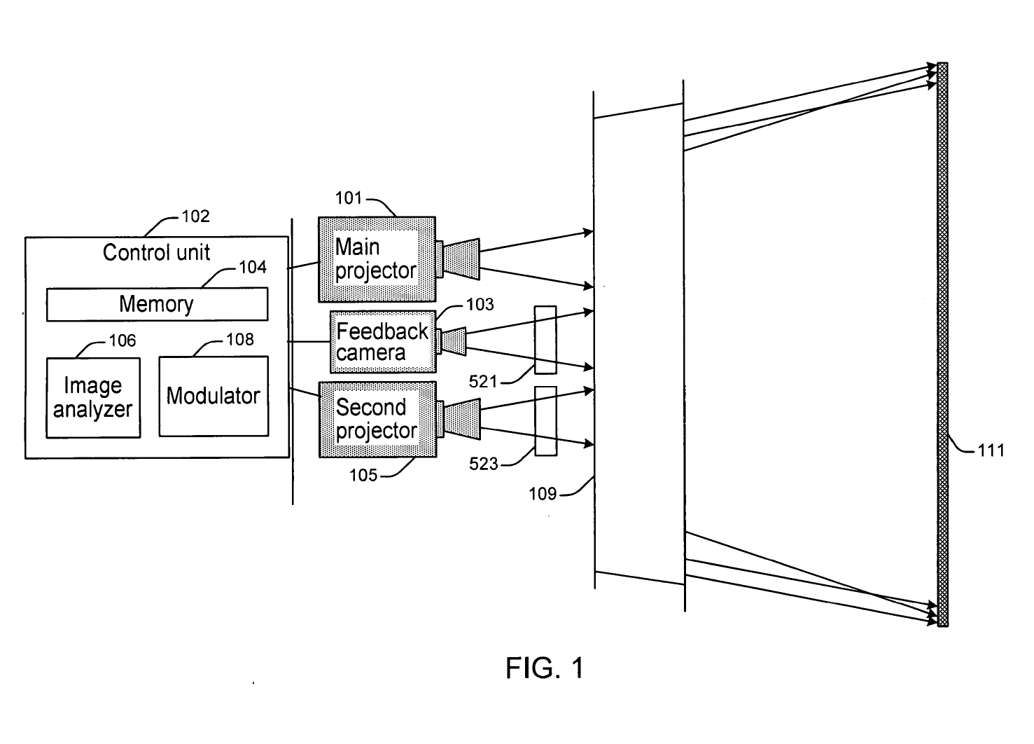

FIG. 1 depicts a high level block diagram of an anti-piracy protection and verification system in accordance with an embodiment of the present invention. In accordance with various embodiments of the present invention, it is to be noted that an anti-piracy protection and verification system of the present invention can include conventional film projectors and/or components of a Digital Cinema projection system. For example, the anti-piracy protection and verification system of FIG. 1 illustratively includes a first or main projector 101 for projecting image content (e.g., movie images) onto a screen 111 (i.e., across a seating area 109). In the embodiment of the present invention depicted in FIG. 1, a feedback device 103 (e.g., a visible light camera) is in communication with a control unit 102. The feedback device 103 records a plurality of consecutive frames of the images of the projected images for communication to the control unit 102. In the system of FIG. 1, the control unit 102 of FIG. 1 illustratively comprises a memory 104 for storing, for example, software configured to carry out the processing steps described herein, an image analyzer 106 for determining image properties (e.g., average luminescence/light levels, variability, color content, etc. of each frame) and determining an ideal portion of each image onto which anti-sampling system content can be added and a modulator 108 for providing video feed comprising modulation of selected areas of the original image content to a second projector 105. The control unit 102 can comprise a separate computer and/or can be included internally within the camera device 103.

The overall number/percentage of consecutive frames to be modulated, according to various embodiments of the present invention, in a given movie or presentation is adjustable and is preferably a number of frames sufficient to render a pirated/camcordered version of the movie unusable. The desired quantity of frames to be modified is readily determinable by one of ordinary skill in the art. For example, in one embodiment of the present invention, at least 30% of the total number of frames in a movie is pseudo-modulated for optimal effectiveness.

The term “anti-sampling system content” used herein can include, for example, content used to thwart camcorders or any other video sampling system. According to an embodiment of the present invention, suitable anti-sampling system content is applied based on the analysis of the plurality of frames by the control unit 102. As such in various embodiments of the present invention, anti-sampling system content which is ‘customized’ to the images is advantageously provided and applied.

Ideal scenes for adding anti-sampling system content in accordance with various embodiment of the present invention can include static scenes with minimal movement/action. Such scenes maximize the desired negative effect on any pirated recording while reducing the possibility that the anti-sampling system content will cause undesirable side effects that would be visible to a human viewer (e.g., flickering, flashes, etc.). As most scenes in a given movie/presentation are static for at least a few seconds (and most movies frames are transmitted at a standard rate of, for example, 24 Hz or 24 frames per second), an analysis of, for example, just three or four consecutive frames by the feedback camera 103 would allow enough 30, time to produce a suitable and effective anti-sampling system image for a given scene.

In the embodiment of FIG. 1, a second projector 105 is provided operably connected to and in communication with the feedback device 103 and/or the control unit 102 and is configured to project the desired anti-sampling system content onto portions of each image of the frames in real time. For example, in various embodiments of the present invention, anti-sampling system content can include modulated visible light such as luma (quantity representative of luminance information) and chroma (quantity representative of color information) temporally and/or spatially modulated light which is virtually invisible to the naked human eye, yet readily detectable on a recording made by a sampling system such as a camcorder.

Preferably, the anti-sampling system content added to content, such as a movie, is ‘customized’ such that, in one embodiment, only the minimal amount/level of modulated visible light necessary to discourage camcorder reproduction yet still be virtually invisible to a human viewer is projected via the second projector 105 onto each respective image. For example, in order to keep additive light levels low, not every area of every image of the selected sequence is ‘pseudo-modulated’ (projected/output with additional modulated visible light). That is, only certain portions (e.g., in one embodiment, random portions) of the screen are affected. Only a portion of each image (e.g., a non-entire portion preferably sufficient to discourage unauthorized camcorder duplication) is pseudo-modulated with, for example, higher frequency visible light, and thus higher frame rates are balanced by the fact that full picture resolution of the original image is not required. This keeps the time-bandwidth well within current manufacturing methods, thus eliminating the need for a high-resolution/high frame rate digital cinema projector. Moreover, the digital content of the original images is not modified in any way, therefore providing theaters with the option of utilizing additional/alternate anti-camcorder methods, such as physical security techniques (e.g., metal detectors, camcorder operation detectors, etc.) in conjunction with the aspects of the present invention.

Anti-sampling system content, in accordance with various embodiments of the present invention, preferably includes light transmitted from the second projector 105 which is preferably modulated temporally at a very high rate (e.g., in one embodiment, at about 120 Hz to about 150 Hz) which in various embodiments of the present invention, can include some spatial modulation as well. The spatial modulation, however, can be at a relatively low modulation period, for example, less than or equal to about 1/100^{th} of the height of the screen. Advantageously, the projected anti-sampling system content (e.g., visible light images transmitted at higher frequencies, for example, above about 120 Hz) from the second projector 105 is virtually invisible to the human eye, yet is readily detected by any sampling system (e.g., a camcorder device) due to the well-known aliasing phenomenon in signal processing. The projected anti-sampling system content in accordance with the present invention causes beat frequencies in any pirated recording of a movie, thus rendering any such pirated recordings useless.

In addition, the feedback device 103 of the system of FIG. 1 advantageously enables real-time evaluation and tuning of the overall system so as to ensure that as close to a minimum effective amount of additional modulated light necessary to effectuate the desired results is utilized and projected onto the content to be protected.

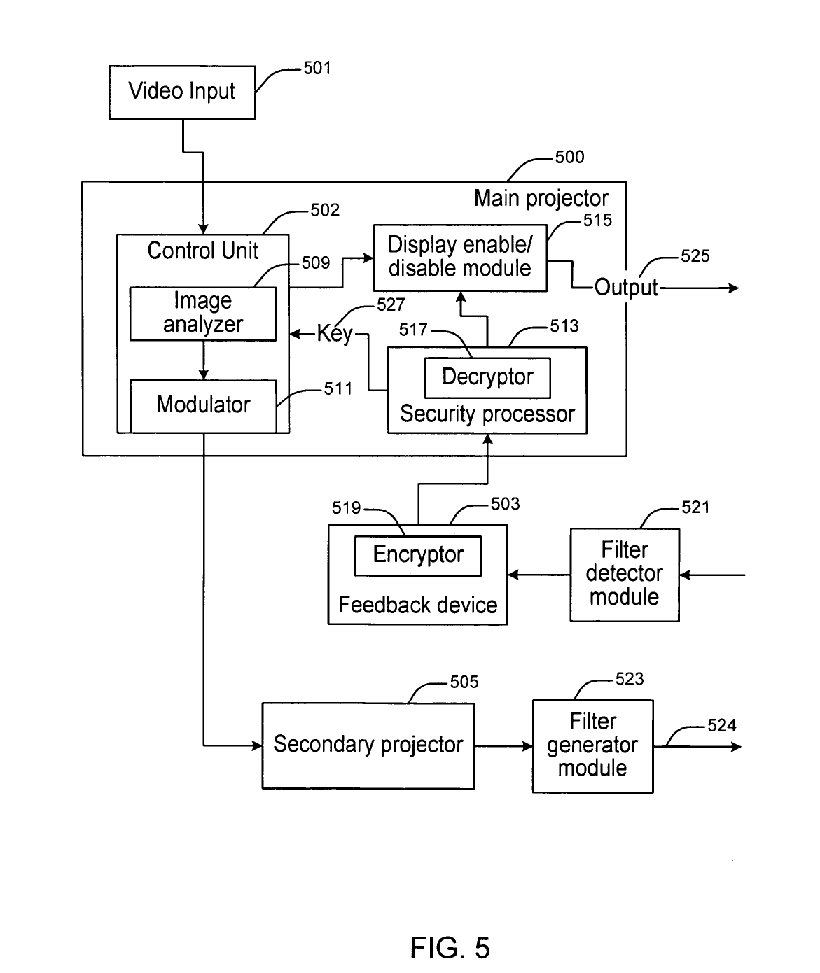

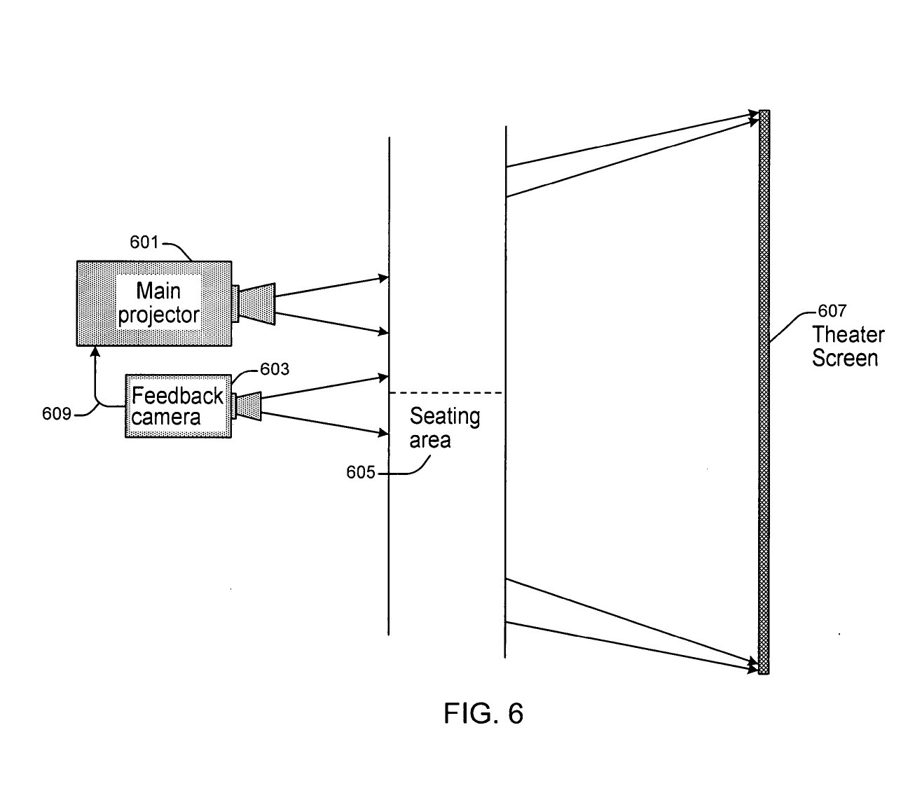

Optionally, in various embodiments of the present invention and as depicted in FIG. 1, a filter generator module 523 can further be provided for generating and sending additional security data (e.g., a signal) in addition to the modulated content from the secondary projector 105, and a filter detector module 521 can be provided in the proximity of the feedback camera 103 or as part of the feedback camera 103 for recovering and detecting the additional security data. The specifics of the modules 521, 523 are explained further below with reference to FIG. 5.

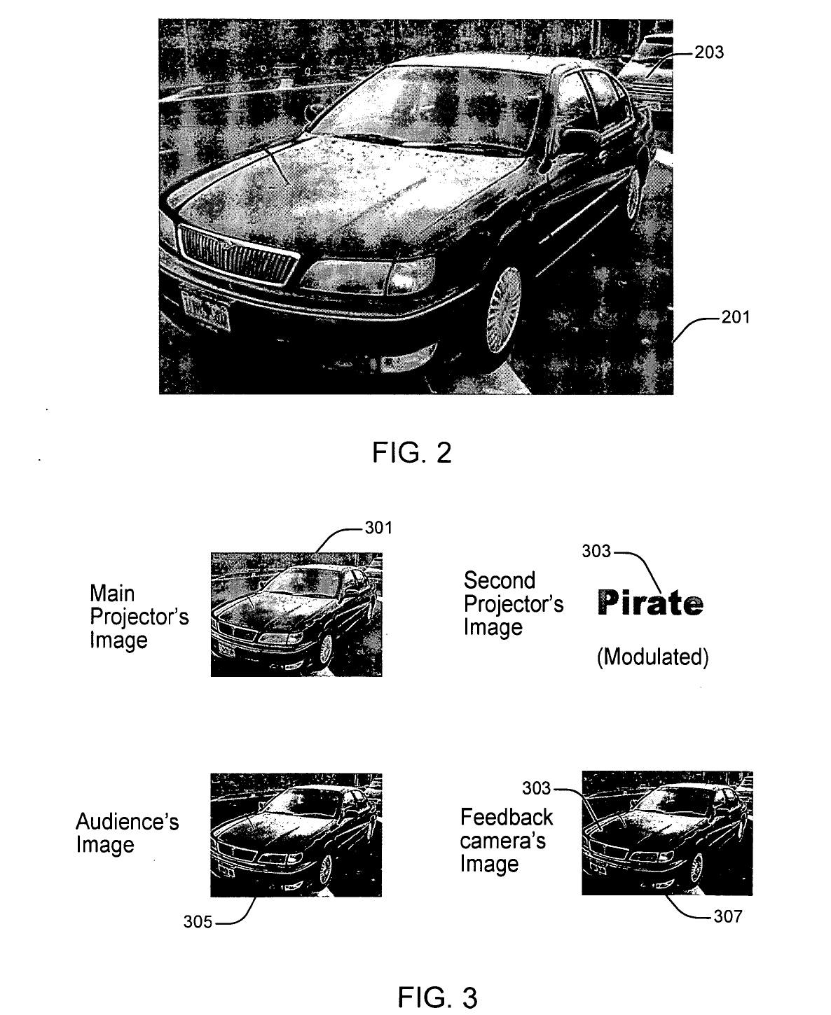

FIG. 2 depicts an exemplary illustration of an image having anti-camcorder content as viewed by a sampling system in accordance with an embodiment of the present invention. For example, as depicted in FIG. 2 anti-sampling system content 203 can include modulated visible light in any shape, configuration, design, letters, etc. preferably covering an amount of the original image that is sufficient to render a sampled pirated recording of the image useless yet is virtually undetectable to the human eye. In the example of FIG. 2, anti-sampling system content 203 comprises the word “PIRATE” projected onto an original image 201.

FIG. 3 depicts an exemplary illustration of images projected by various components of an anti-camcorder system in accordance with an embodiment of the present invention. In the example of FIG. 3, the image 301 projected by the main projector comprises content desired to be protected. Anti-sampling system content (e.g., a modulated visible light image) 303 is projected by a second projector. In the image(s) seen by the audience 305, any anti-sampling system content is virtually invisible, and the image appears the same as original unmodified image 301. However, in an image 307 taken by a feedback camera, the modulated anti-sampling system content 303 is clearly visible.

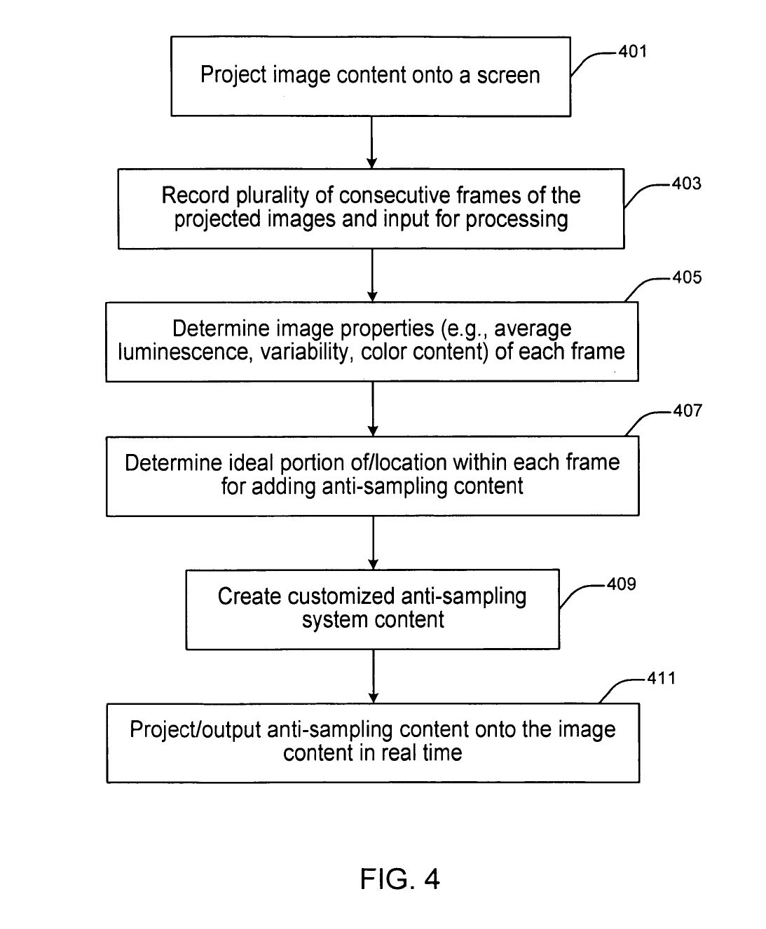

FIG. 4 depicts a flow diagram of a method for providing anti-camcorder system content in accordance with an embodiment of the present invention. The method begins at step 401, at which a first projection device projects images onto a screen (e.g., a theater screen). The method then proceeds to step 403.

At step 403, at least a plurality of consecutive frames of the images are recorded by a feedback camera and input to a processor/computer which can be external or internal with respect to the feedback device. The method then proceeds to step 405.

At step 405, the properties of the input images (e.g., their average luminescence/light level, color content and/or variability or movement between the frames, etc.) are determined, for example, by the processor/computer 102. The method then proceeds to step 407.

At step 407, an area (e.g., amount and location) of each image for adding anti-sampling system content thereon is determined. In various embodiments of the present invention, only certain (“non-entire”) or random portions of each image are affected. The method then proceeds to step 409.

At step 409, suitable anti-sampling system content is created customized to the properties of the analyzed images. The method then proceeds to step 411.

At step 411, the anti-sampling system content is communicated to a second projector, which projects the anti-sampling system content, for example, in the form of modulated visible light, onto the desired portions of each image in each selected sequence, for example, in real time. The method can then be exited.

In various embodiments of the present invention, a control unit of the present invention, such as the control unit 102 of FIG. 1, can further include a database (not shown) for containing, for example, anti-sampling system content in the form of pre-determined images, letters, numbers, designs, logos, etc. at pre-determined light levels, colors, etc. In one embodiment of the present invention, such a database can be included in the memory 104 of the control unit 102. In alternate embodiments, such a database can also be externally provided on a server accessible via a network (e.g., Internet). As previously recited however, in alternate embodiments of the present invention, the modulator 108 can include the ability to create new or customized anti-sampling system content.

FIG. 5 depicts a high level block diagram of a system for providing and verifying anti-sampling content in accordance with an embodiment of the present invention. That is, FIG. 5 illustrates a high level block diagram of a system using multiple projectors for security verification of anti-camcorder content. In the system of FIG. 5, a video input 501 is communicated to a control unit 502 of a main projector 500 to undergo ‘normal’ processing' for providing image content for display on a screen. The control unit 502 of FIG. 5 illustratively comprises an image analyzer 509 and a modulator 511. The processed content can be analyzed by the image analyzer 509 for determining the type/structure/layout of anti-camcorder content (e.g., modulation) to be projected by the secondary projector 505. At the same time, the processed image content is communicated to a display enable module 515, which, depending on the outcome of the verification process discussed further below, enables or disables its display and projection onto a screen. Assuming the monitored anti-sampling content is verified, the processed image content is enabled by module 515 and output 525 to a screen for viewing.

In the system of FIG. 5, the modulator 511 operably connected to and in communication with the image analyzer 509 can provide video feed comprising modulation of the original image content as well as special key encrypted modulation using a key 527 input to the image analyzer from a security processor 513. The key 527 provides an additional security measure in facilitating the generation and detection of key-encrypted modulation which cannot be created or detected without the key.

The modulated anti-camcorder content is sent to a secondary projector 505 which, optionally, projects the security content to a filter generator module 523. The filter generator module 523 can include an infrared (IR) filter configured to generate a separate ‘invisible’ channel or signal as an additional check that the secondary projector is operating correctly and projecting the desired and expected anti-camcorder content. The module 523 does not change the modulated signal from the modulator 511 nor does it generate a signal intended to disrupt a camcorder. In the system of FIG. 5, the anti-camcorder content is output 524 from the secondary projector 505 onto the image content 525 projected on a screen.

A verification process in accordance with an embodiment of the present invention as depicted in FIG. 5 can be described as follows. A feedback device 503 can be provided for recording the content ('recorded content'/'feedback image') being displayed on a screen in real-time. The ‘recorded content’ includes an external visual recording created by the feedback device of the image content that is actually being displayed on the screen. The feedback image/recorded content can comprise an isolated section of the screen where a code is passed, or can alternatively cover the entire screen to evaluate the entire picture content.

In one embodiment of the present invention, the feedback device 503 can comprise a simple USB camera and can include an optional filter detector module 521 for detecting any channel or signal created by the optional filter generator module 523, and can include an encryptor 519 for encrypting the recorded content. In the system of FIG. 5, the recorded content is communicated to the security processor 513 where the recorded content is decrypted via a decryptor 517, analyzed and compared with an expected content. The security processor 513 determines whether or not the anti-piracy security is active and in accordance with expected parameters. For example, the ‘expected content’ can include the anti-sampling content which was previously known and selected by the system to have been applied to the image content. The outcome of the decision is communicated to the display enable/disable module 515 which accordingly enables or disables the display of the image content depending on whether the recorded content matches the expected content. For example, the enable/disable module 515 can be configured for disabling the projection of the image content on the screen if the recorded content does not match the expected content.

FIG. 6 depicts a high level block diagram of an anti-piracy protection and verification system in accordance with an alternate embodiment of the present invention. That is, the system of FIG. 6 depicts an embodiment in which additional or secondary projectors and filters are not utilized. In this alternate embodiment, a main projector 601 is provided for projecting modulated image content across a seating area 605 onto a theater screen 607 and a feedback camera 603 is provided for monitoring and recording the modulated content and communicating a video feed 609 including modulation of the original image content.

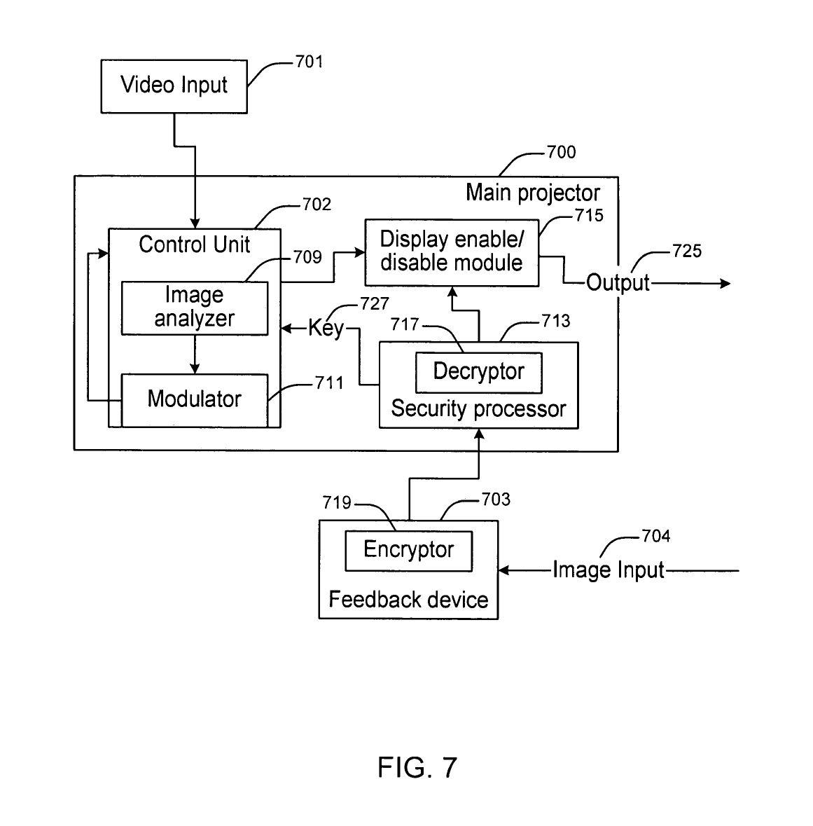

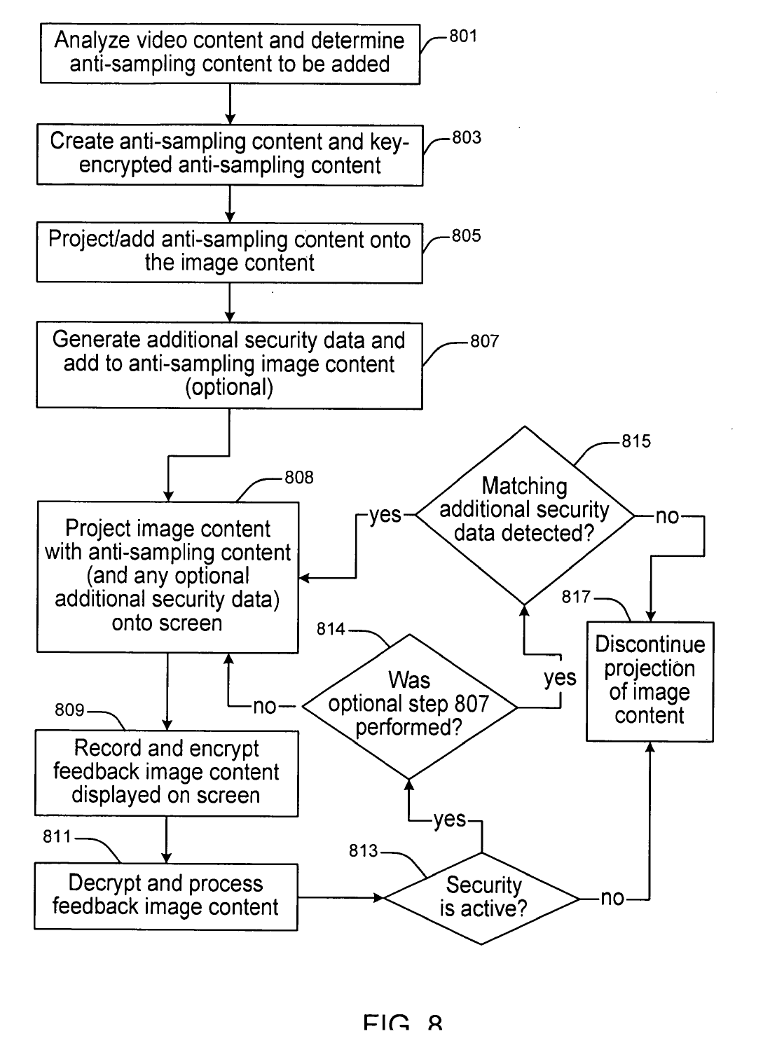

FIG. 7 depicts a more detailed diagram of the system of FIG. 6 in accordance with an embodiment of the present invention. That is, in FIG. 7, a video input 701 can be communicated to a control unit 702 of a main projector 700 to undergo ‘normal processing’ for providing image content for display on a screen. The processed content can then be analyzed by an image analyzer 709 for determining the type/structure/layout of anti-camcorder content (e.g., modulation) to be projected by the main projector 700. At the same time, the processed image content is output to a display enable module 715, which, depending on the outcome of the verification process as discussed further below, enables or disables its display and projection onto a screen. Assuming the monitored anti-sampling content is verified, the processed image content is enabled by module 715 and output 725 to a screen for viewing.

In the system of FIG. 7, a modulator 711 operably connected to and in communication with the image analyzer 709 can provide a video feed comprising modulation of the original image content and optionally, a special key encrypted modulation using a key 727 input to the image analyzer from a security processor. The key 727 provides an additional security measure in facilitating the generation and detection of key-encrypted modulation which cannot be created or detected without the key.

The modulated anti-camcorder content and key-encrypted modulation is communicated to the processor 707 and, assuming that the verification process approves the content, it is enabled by display enable module 715 for output 725 together with the original image content onto a screen.

As previously described, in the system of FIG. 7 the verification process can include a feedback device 703 provided for recording the content (feedback image input 704) being displayed on a screen. The feedback image can be isolated to a section of the screen where, for example, a code is contained, or cover the entire screen to evaluate the entire picture content.

In various embodiments of the present invention, the feedback device 703 can comprise a simple detection device, such as a USB camera, and can optionally include an encryptor 719 for encrypting the recorded content. The recorded content is communicated to the security processor 713 where it is decrypted via decryptor 717, analyzed and compared with an expected content. The security processor 713 determines whether or not the security is active (i.e., is in accordance with expected parameters). The outcome of the decision is sent to the display enable module 715 which accordingly enables or disables the image content.

The feedback device of the present invention, such as the feedback device 703 of FIG. 1, is, in various embodiments of the present invention, provided in proximity to a respective projection screen for recording content played on the screen in real-time. In various embodiments of the present invention, the recorded content of the feedback device can also optionally be encrypted to discourage piracy as previously described. Advantageously, the cost of the feedback system of the various embodiments of the present invention can be kept low since it is not required for the feedback device (camera) to be high-resolution, have a high frame rate, or even need a high level of security. It is not necessary for the feedback device to be a very high security system for at least the following reasons:

1. The camera may be low cost and thus would typically produce low quality video, which is undesirable for pirated copying.

2. When the anti-camcorder content is applied and operating properly, the camera's recorded content will be ‘contaminated’ with the anti-camcorder content and thus be non-viewable content that is unsuitable for pirating.

3. Since the security verification process is a real-time system, each frame of content is unique. Simple and basic processing techniques can thus be used to check for some correlation between the movie's original content and the image being recorded by the feedback camera. Techniques as simple as scene change detection can be used to verify that the feedback image content is from the real-time image displayed on the screen.

4. Since the image content is encrypted, for example; over a cable, it is a tamper-resistant system. Further, the encryption can be simple and low-cost, since there would be little motivation to decrypt such low-resolution, anti-camcorder/altered content.

5. The output of the feedback camera can be limited to include a few sample frames to every one frame of the movie, thus intentionally producing ‘jitter’ in the output of the feedback camera's recorded content. The frame rate could also be varied from the frame rate of the movie content to further render the feedback camera useless for producing a recorded copy of the movie which may be used for pirating purposes.

FIG. 8 depicts a flow diagram of a method for providing and verifying anti-camcorder content in real-time in accordance with an embodiment of the present invention. The method of FIG. 8 begins at step 801, in which video content is analyzed for determining anti-sampling content to be added to the content. The method then proceeds to step 803.

At step 803, anti-sampling content and, optionally, key-encrypted anti-sampling content are created. The method then proceeds to step 805.

At step 805, the created anti-sampling content and the optional key-encrypted content are added/projected to the image content. The method then proceeds to step 807 or step 808.

Alternatively, at step 807 additional security data in the form of, for example, a separate signal or channel can be generated (e.g., using an IR filter) and added to the anti-sampling image content. The method then proceeds to step 808.

At step 808, the image content with anti-sampling content, and any optional additional security data, if applicable, is projected onto a screen for display. The method then proceeds to step 809.

At step 809, the image content displayed on the screen is recorded and optionally encrypted in real-time. The method then proceeds to step 811.

At step 811, the recorded content is decrypted and processed as previously described. The method then proceeds to step 813.

At step 813 it is determined whether the anti-camcorder security is currently active (e.g., whether the feedback image content matches the ‘expected content”; the actual anti-sampling content+the original image content). If no, the method proceeds to step 817 at which point the image content is stopped from further projection on the screen. If yes, the method proceeds to step 814.

At step 814, it is determined whether the optional additional security data described in step 807 was added. If the optional security data was not added, the image content with anti-sampling content is continued to be projected onto the screen without interruption. If the optional security data was added, the method proceeds to step 815.

At step 815, the security data is retrieved from the recorded content and compared with the originally added security data and it is then determined whether the added security data matches the retrieved security data. If there is no match, the method returns to step 817 wherein projection of the image content on the screen is discontinued. If the originally added security data matches the retrieved security data, the image content with anti-sampling content is continued to be projected onto the screen without interruption. The method can then be exited.

Having described preferred embodiments for a method, apparatus and system for providing an anti-piracy protection and verification system (which are intended to be illustrative and not limiting), it is noted that modifications and variations can be made by persons skilled in the art in light of the above teachings. It is therefore to be understood that changes may be made in the particular embodiments of the principles disclosed which are within the scope and spirit of the inventive principles as outlined by the appended claims. Having thus described the invention with the details and particularity required by the patent laws, what is claimed and desired protected by Letters Patent is set forth in the appended claims.

1. A method for providing and verifying anti-camcorder content comprising the steps of:
determining, from at least a portion of a projected original image content, anti-sampling content suitable for projection contemporaneously with said original image content such that the anti-sampling content is not visible to a human eye but is destructive to the image quality of the original image content when recorded by a sampling device;
projecting said anti-sampling content contemporaneously with said original image content; and
capturing said contemporaneously projected content for verifying that the anti-sampling content is present in said captured content.

2. The method of claim 1, wherein a plurality of consecutive frames of said original image content are captured and image properties of said captured frames are analyzed for determining said suitable anti-sampling content.

3. The method of claim 2, wherein the image properties of said captured frames include at least one of average luminescence, variability and color content.

4. The method of claim 1, wherein the anti-sampling content is projected onto only a portion of said original image content.

5. The method of claim 1, wherein the anti-sampling content comprises modulated visible light.

6. The method of claim 5, wherein the modulated visible light comprises light modulated temporally at a rate between 120 Hz to 150 Hz.

7. The method of claim 1, further comprising projecting security data along with said anti-sampling content and determining if captured security data matches said projected security data.

8. The method of claim 1, wherein if the presence of said anti-sampling content in said captured content is not verified, the projection of said original image content is disabled.

9. An anti-piracy protection system comprising:
a content capturing device configured to capture at least a portion of a projected original image content;
a control unit for determining, from at least the captured portion of the projected original image content, anti-sampling content suitable for projection contemporaneously with said original image content such that the anti-sampling content is not visible to a human eye but is destructive to the image quality of the original image content when recorded by a sampling device; and
a projection device for projecting said anti-sampling content contemporaneously with said original image content;
wherein said content capturing device captures said contemporaneously projected content for verification by said control unit that the anti-sampling content is present in said captured content.

10. The system of claim 9, wherein said control unit is operably connected to a projection source of said original image content and wherein if the presence of said anti-sampling content in said captured content is not verified, the projection of said original image content is disabled.

11. The system of claim 10, wherein said projection source comprises a display enable/disable module configured for disabling the projection of said original content if the captured portion of said original image content does not match an expected content.

12. The system of claim 9, wherein the content capturing device comprises a sampling device.

13. The system of claim 9, wherein the content capturing device comprises a visible light camera.

14. The system of claim 9, wherein said projection device comprises a first projection device for projecting said anti-sampling content contemporaneously with said original image content and wherein a second projection device is used for projecting said original image content.

15. The system of claim 9, wherein said projection device comprises a single projection device for projecting said original image content and said anti-sampling content, contemporaneously.

16. The system of claim 9, wherein the control unit is an integrated unit in said projection device.

17. The system of claim 9, further comprising an enable/disable unit for disabling the projection of said original image content if the presence of said anti-sampling content in said captured content is not verified.

18. The system of claim 9, further comprising a security data unit for generating security data to be projected along with said anti-sampling content.

19. The system of claim 9, wherein said content capturing device further comprises an encryptor for encrypting the captured original image content.

20. The system of claim 19, wherein said projection device includes a filter generator module for generating a signal for projection onto the screen.

21. The system of claim 20, wherein said content capturing device further includes a filter detector module for detecting the signal created by the filter generator module.

22. An anti-piracy control unit comprising:
an image analyzer for determining and analyzing image properties of a projected original image content; and
a modulator for determining, using at least the determined and analyzed image properties of the original image content, anti-sampling content suitable for projection contemporaneously with said original image content such that the anti-sampling content is not visible to a human eye but is destructive to the image quality of the original image content when recorded by a sampling device.

23. The anti-piracy control unit of claim 22, wherein said determined anti-sampling content is communicated to a projection device for projecting said anti-sampling content contemporaneously with said original image content.

24. The anti-piracy control unit of claim 22, wherein the anti-sampling content is projected onto a non-entire portion of each respective image of said original image content.

25. The anti-piracy control unit of claim 22, wherein the image properties include at least one of average luminescence, variability and color content.

26. The anti-piracy control unit of claim 22, wherein the anti-sampling content is projected in real time onto image frames of said original image content.

27. The anti-piracy control unit of claim 22, wherein the anti-sampling content comprises modulated visible light.
